(19) United States
(12) Patent Application Publication
(10) Pub. No.: US 2026/0178635 A1
(43) Pub. Date: Jun. 25, 2026

(54) Composite Vector Index for Performing Vector Search in Databases

(71) Applicant: Couchbase, Inc., San Jose, CA (US)

(72) Inventors: Deepkaran Singh Salooja, Surrey (CA); Sitaram Vemulapalli, San Jose, CA (US); John Sae Liang, Palo Alto, CA (US); Bingjie Miao, Englewood, CO (US); Kamini Manoharlal Jagtiani, Los Altos, CA (US); Amit Kulkarni, Bengaluru (IN); Raghupathi Keshava Murthy, Union City, CA (US); Varun Velamuri, Hyderabad (IN); Sai Kommaraju, Bengaluru (IN); Donald Haggart, Livingston (GB)

(21) Appl. No.: 19/216,660

(22) Filed: May 22, 2025

(30) Foreign Application Priority Data
Dec. 23, 2024 (IN) 202411102166

(51) Int. Cl. G06F 16/334; G06F 16/35

(52) U.S. Cl. CPC G06F 16/3347; G06F 16/35

(57) ABSTRACT

A system stores a composite vector index based on vector fields and scalar fields. Each vector field comprises vector embeddings and each scalar field comprises scalar values. The values of a vector field are grouped as cells having a centroid value. The system receives a query based on at least a vector field and a scalar field. The system identifies a set of centroids of cells of the vector field based on the query and accesses records from the cells corresponding to the set of centroids. The system determines a subset of records of the cells corresponding to the set of centroids that satisfy a constraint based on the scalar fields specified in the query. The system determines a result set based on the subset of records by performing vector comparisons for the subset of records. The system accordingly reduces the number of vector operations performed for processing queries.

### CROSS REFERENCE TO RELATED APPLICATION

This application claims the benefit of Indian Provisional Application No. 202411102166, filed Dec. 23, 2024, which is incorporated by reference in its entirety.

### BACKGROUND

### Field of Art

This disclosure relates in general to document databases, and in particular to building composite vector indexes and using them for processing queries based on vector fields and scalar fields.

### Description of the Related Art

Database systems store data of various types such as integer, binary data, strings, date, arrays, objects, and so on. Database systems receive and process queries that require comparison between data values. For example, to select records that have a date value within a threshold of a specified date value, the database system may compare stored date values of records with the date value specified in the database query. Databases create indexes for executing such queries efficiently. Database systems receive database queries specified using the syntax of a query language such as SQL (structured query language). However, with increased use of machine learning based language models, systems support natural language questions. For example, chatbots receive natural language questions from users and provide answers based on the natural language questions. Such systems are able to perform semantic searches based on natural language questions, for example, by identifying natural language text that has semantic match with the input even if there is no textual match. However, such systems are unable to efficiently process requests that specify a constraint based on natural language input as well as scalar fields. For example, these systems are inefficient in answering a request to retrieve objects that have certain attributes such as color, size, etc. and also have a description that is similar to a natural language description provided as input.

### SUMMARY

A system allows querying data including vector fields and scalar fields. The system stores a composite vector index associating a plurality of fields. The plurality of fields includes one or more vector fields and one or more scalar or array fields. Each vector field comprises vector embeddings and each scalar field comprises scalar values and an array field comprises of array of scalars of objects. The values of a vector field are grouped as cells and each cell is associated with a centroid value. The system receives a query based on at least a vector field and a scalar field from a client device. The system extracts a first component of the query based on the vector field and a second component of the query comprising a constraint based on the scalar field.

The system identifies qualified indexes to evaluate the query. According to an embodiment, the system identifies a set of cells comprising data relevant for processing a query. The cells are identified by selecting centroids of the cells that satisfy certain constraints of the query. The system filters records of the identified cells using constraints of the query using one or more scalar fields according to the second component to eliminate records. The elimination of the records reduces the number of vector fields that are subsequently processed. The system determines a subset of records of the identified cells that satisfy the constraint specified in the second component of the query. The system accesses records from the cells corresponding to the set of centroids and further filters them based on the first component of the query that requires vector comparison with vector fields. The system determines a result of the query based on the subset of records and sends the result of the query to the client device.

According to an embodiment, the first component of the query specifies a measure of a distance from a particular vector field value such that the query represents a request for records based on their distance from the particular vector field value. For example, the first component of the query may be an order by clause that orders results based on a distance of the vector field from a particular vector field value.

According to an embodiment, the system stores a graph comprising nodes representing records such that an edge exists between a pair of nodes if a vector distance between values of the vector field of the records corresponding to the nodes is within a threshold value. The system traverses the graph to identify records within a neighborhood of a particular record.

According to an embodiment, a vector field stores natural language text such that the vector embeddings represent a vector representation generated by providing the natural language text to a neural network.

According to an embodiment, a vector field stores media objects such that the vector embeddings represent a vector representation generated by providing a media object to a neural network, wherein the media object is one of an image, a video, or an audio.

According to an embodiment, the system performs clustering of a set of records based on vector fields to determine cells and determines a centroid for each cell.

The database may be a relational database, wherein each record is represented by one or more rows of tables stored in the relational database, wherein a field is represented by a column of a table.

The database may be a document database, wherein each record is represented by a document or a portion of a document and a field is represented by an attribute of the document.

Embodiments of the invention include computer-implemented methods described herein, non-transitory computer readable storage media storing instructions for performing steps of the methods disclosed herein, and systems comprising one or more computer processors and computer readable non-transitory storage medium to perform steps of the computer-implemented methods disclosed herein.

### BRIEF DESCRIPTION OF THE DRAWINGS

FIG. 1 is an embodiment of a block diagram of a system environment in which a database system operates, according to an embodiment.

FIG. 2 illustrates an example architecture of the database system, according to an embodiment.

FIG. 3 is a flowchart of one embodiment of a method for creating a composite vector index, according to an embodiment.

FIG. 4 is a flowchart of one embodiment of a method for indexing and querying spatiotemporal data, indexing and querying spatiotemporal data.

FIG. 5 is a high-level block diagram illustrating a functional view of a typical computer system for use as one of the entities illustrated in the system environment of FIG. 1 according to an embodiment.

The figures depict embodiments of the present disclosure for purposes of illustration only. One skilled in the art will readily recognize from the following description that alternative embodiments of the structures and methods illustrated herein may be employed without departing from the principles, or benefits disclosed, of the disclosure described herein.

### DETAILED DESCRIPTION

### System Overview

The system receives a request that comprises a natural language question combined with constraints based on fields (or attributes) stored in a database. The system may perform similarity search or semantic search. The constraints can be processed using traditional database query processing techniques such as use of indexes such as B-tree based indexes. However, answering the natural language question requires performing similarity search or semantic search based on vector representations of natural language text. Processing constraints based on simple database types such as scalar values can be performed without converting the values to a vector representation. The system uses indexes to identify relevant records for similarity or semantic searches. Examples of simple database values are integer, floating point values, date type, string values, and also arrays of simple data types. The system allows users to request information based on a combination of natural language question and constraints based on database types such as scalar values. The processing of the natural language question is performed using machine learning based language models such as large language models (LLMs). However, the data represented using simple database types such as scalar data types may be proprietary data of an enterprise and the machine learning based language model may never have been trained on that data.

As an example, the system may allow users to request “shoes that are sporty and have size 10 and a price range of $50-100. The user request includes a constraint based on simple database types such as size and price which are both integers. However, the request also includes a natural language question component that requests shoes that are sporty since there is no well-defined expression that can be specified using a database query language to process the request. This natural language question requires semantic analysis, for example, based on description of the shoes. The system is able to process such queries that include a component that requires semantic analysis by generating a vector representation (i.e., embedding) of data and a database query component that can be processed using the traditional database query processing techniques, for example, using B-tree indexes. As another example, the system may store comments from users for certain items and receive a request for all items that have price range $100-200 and that received user comments that indicated a positive sentiment. Determining the sentiment of the user comments may require converting the comments to a vector representation whereas identifying the items within a price range can be performed using traditional B-tree indexes or any other type of efficient query processing technique.

The system uses the constraints based on scalar values or simple database types to select a subset of records that need to be processed. The subset of information is provided as a context to the machine learning based language model for answering the natural language question. Accordingly, the system performs semantic search to use a language model, for example, a large language model (LLM) to answer a natural language question while minimizing hallucinations of the LLM.

A system may perform queries based on multi-dimensional data by converting multiple dimensions into a single dimension and then performing simple query using that single dimension. However, with multidimensional vector representations that have hundreds or thousands of dimensions, this technique is not feasible. The combined dimension would have such large values that will not be feasible to process and will be highly inefficient to process even if the system could generate such values.

The system stores a composite index that stores vector fields (for data that is converted to vector representations) as well as scalar fields. The system receives a query that in includes (1) a natural language question component that requires similarity search based on vector representations of data and (2) a database query component that includes a constraint based on scalar fields. The system selects a subset of data (e.g., a subset of records or documents) based on the database query component. The system processes the natural language question component of the request using the subset of the data. Since processing of natural language questions using vector representations is highly computation intensive, the system achieves significant improvement in efficiency by reducing the amount of data that is processed based on vector representations. The system may perform scalar based filtering as a post-filtering step after applying vector fields via include columns.

### System Environment

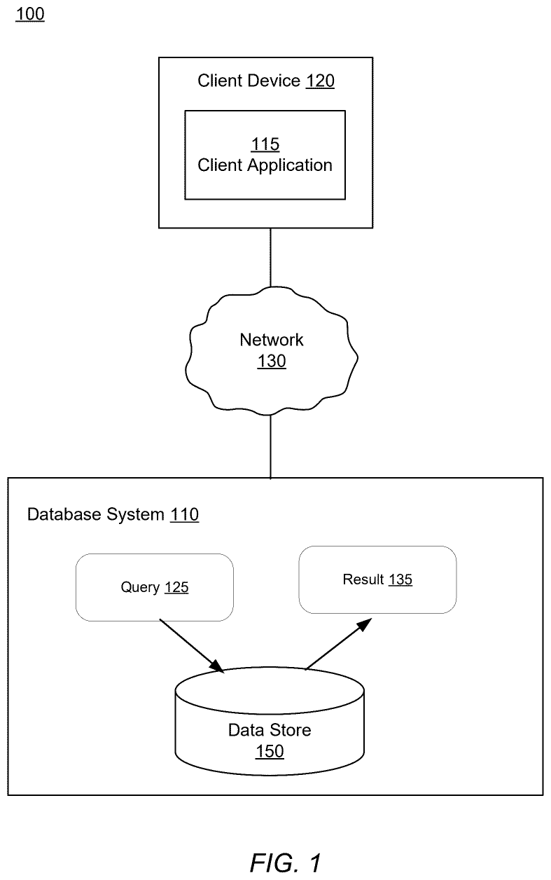

FIG. 1 is an embodiment of a block diagram of a system environment in which a database system operates, according to an embodiment. In the embodiment shown, the system environment includes a database system 110, a client device 120, and a network 130. Other embodiments may use more or fewer or different systems than those illustrated in FIG. 1. Functions of various modules and systems described herein can be implemented by other modules or systems than those described herein.

The client device 120 sends database queries for data stored in database system 110. For example, a client application 115 running on client device 120 sends requests to access data (e.g., database queries) to the database system 110 over the network 130. The client application 115 then receives results 135 in response to the query 125 from the database system 110 sent back over the network 130.

The database system 110 stores data in a data store 150. The database system 110 receives query 125 based on the data stored in the data store 150. For example, a query 125 may be received from a client application 115 running in a client device 120. The database system 110 processes the query 125 using the data stored in the data store 150 to determine results 135 that satisfy the query 125. The database system 110 returns the results 135 to the client application 115 that sent the query 125.

The data store 150 may be a relational database that stores records in database tables or relations such that the database system 110 is a relational database system. The data store 150 may store data as documents that include attributes or fields such that the database system 110 is a document database system. But types of database systems may store information describing entities or items, for example, products of an enterprise store, user information, and so on. The entities represented in the database system 110 include fields. The fields may be stored as columns of a table in a relational database system or as attributes of documents in a document database system. The data stored in the data store 150 may include scalar fields, for example, fields of type integer, date, string, floating point numbers, and so on. For example, if the entity represented in the database system is a product of an enterprise, the scalar fields may represent price of the product, a name of the product and so on. Comparison of scalar fields may be performed by matching the values stored in the field. For example, if the scalar field is of type date representing the time when an item was acquired, the database system 110 may determine whether an item was acquired before another item by comparing the values stored in the date fields. Similarly, if the scalar field is an integer value representing a price of an item, the database system 110 can determine the items within a price range by comparing the values stored in the price field.

The database system 110 may also be referred to herein as a system or an online system. The interactions between the client device 120 and the database system 110 are typically performed via a network 130, for example, via the Internet. In one embodiment, the network uses standard communications technologies and/or protocols. Example networking protocol include the transmission control protocol/Internet protocol (TCP/IP), the user datagram protocol (UDP), internet control message protocol (ICMP), etc. The data exchanged over the network can be represented using technologies and/or formats including JSON, the hypertext markup language (HTML), the extensible markup language (XML), etc. In another embodiment, the entities can use custom and/or dedicated data communications technologies instead of, or in addition to, the ones described above. The techniques disclosed herein can be used with any type of communication technology, so long as the communication technology supports receiving by the database system 110 of web requests from a sender, for example, a client device 120 and transmitting of results obtained by processing the web request to the sender.

### System Architecture

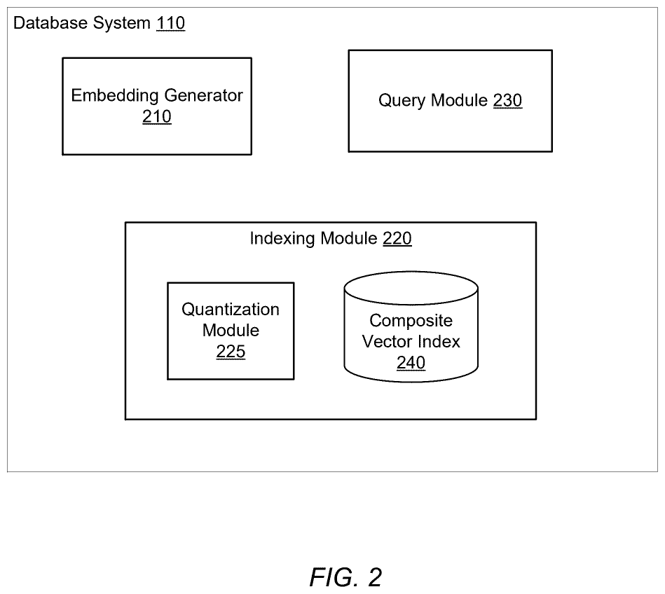

FIG. 2 illustrates an example architecture of the database system, according to an embodiment. The database system includes an embedding generator 210, an indexing module 220, and a query module 230. Other embodiments may include more of fewer modules than those indicated herein.

The embedding generator 210 receives data of certain data types and generates a vector representation of that data. The vector data is multi-dimensional. The number of dimensions can be large, for example, several thousand dimensions, each dimension represented using a floating-point number. For example, the embedding generator 210 receives data that represents natural language text and generates a vector representation of the natural language text. The embedding generator 210 may receive data of other types such as images, audio data, video data, and so on and generate a vector representation of the data. According to an embodiment, the embedding generator 210 comprises a machine learning based model, for example, a neural network with multiple layers. The embedding generator 210 provides an input to the neural network and extracts the output of an internal layer of the neural network as the vector representation of the input. The vector representation of an input is also referred to herein as an embedding of the input.

The database system compares vector representations of input data to perform semantic comparison of inputs. For example, the database system may compare two natural language inputs to determine whether they are semantically similar even if their textual representations are different. The database system can also compare inputs of two different data types, for example, a natural language text with an image to determine whether the natural language input describes the content of the object. As another example, the database system may compare a natural language input with an audio input to determine whether the natural language input describes the content of the audio input. For example, the audio input may represent certain type of music and the natural language input may provide a natural language description of the music. The database system 110 determines the vector representations of each type. The vector representation of the inputs has the same number of dimensions, thereby allowing comparison of the vector representation. The database system 110 compares the vector representations to determine whether the two inputs are similar. The database system 110 may compare the vector representations using vector distances or using a similarity metric such as cosine similarity metric. For example, if the database system 110 determines that the vector representations of two inputs are within a threshold distance of each other, the database system 110 determines that the two inputs are similar to each other. According to another embodiment, the database system 110 may determine vector distances between vectors to select a subset of vectors that are near each other. For example, the database system 110 may determine a vector representation of an input and select the nearest neighbors of the input within a set of values by determining the vector distances of the input with vector representations of each of the set of values and ranking the vector distances to determine a subset of closest values by ranking the vector distances and selecting the values that have the smallest vector distances.

The indexing module 220 creates a composite vector index 240 that includes a plurality of fields. The composite vector index allows a user to include one or more vector field along with any number of scalar fields in an index in any order. A field may be a vector field that stores values obtained by generating vector embeddings from an input and storing the vector embeddings. The input field may represent natural language text. The input field may represent a media object, for example, an image, an audio, or a video. The indexing module 220 invokes the embedding generator 210 to generate vector embeddings of the input and store the vector embeddings in the composite vector index 240. According to an embodiment, the vector embeddings are obtained from an external system and the system imports the embeddings from the external system and stores that for processing queries. A field may be a scalar field, for example, a field of a scalar data type such as an integer, date, floating point value, or a string. Scalar values are stored and processed using the field value as it is received. For example, a scalar value of string type is stored using a string representation, for example, a character array and compared using string comparison. In contrast, even if a natural language text is received as a string value, if the natural language text stored as a vector field, the indexing module 220 generates a vector embedding from the input natural language text and uses the vector embedding to compare the natural language text with other natural language text values. The composite vector index 240 may include both vector fields as well as scalar fields.

According to an embodiment, a composite vector index is an inverted file index (IVF) with quantization. Accordingly, the vector space represented by the vector field is divided into cells, each cell representing a subset of the vector space. A cell may be a Voronoi cell. A set of Voronoi cells represent regions into which a vector space is divided by using a Voronoi tessellation process relative to a specific set of seed points. A Voronoi cell includes all the points that are closer to a particular seed point than to any other seed point. The indexing module 220 performs clustering of a set of data points in the vector space to determine clusters of points that are used as cells. The indexing module 220 may perform k-means clustering. The indexing module 220 may start with a set of data points, referred to as training points to determine the cells. If more data points are received, the indexing module 220 may add them to existing cells, create new cells or merge existing cells. According to an embodiment, the indexing module 220 determines a sampled subset of a full vector dataset and uses IVF to compute the Voronoi cells and centroid vector for each cell. The indexing module 220 may determine the number of cells/centroids based on a predetermined set of rules. The resulting set of centroids is each assigned a centroid ID. The map of centroid ID and centroid vector is referred to herein as a codebook.

The indexing module 220 may store in a codebook, additional information to support a quantization scheme. According to an embodiment, the indexing module 220 includes a quantization module 225 that uses a quantization scheme that breaks up the vector space into subspaces. Each subspace has a fixed number of centroids, identified by a code. A vector is then represented by combining the codes of the nearest centroids in all the subspaces. The codebook may additionally include the mapping between the code and its centroid in each subspace.

According to an embodiment, the quantization module 225 uses a quantization scheme that maps floating point data to a series of integers. For example, 8-bit quantization scheme splits the range of floats into 255 buckets. The codebook may additionally contain the information generated by the scalar quantizer after training.

According to an embodiment, the indexing module 220 creates an index with a VECTOR field and converts the field into two fields—the centroid ID of the cells and code. The indexing module 220 uses the codebook to find the nearest centroid ID for the vector, determines the quantized code for the vector, and stores the two computed values (centroid ID, code) in the index entry. Similarly for scans, the indexing module 220 may use the codebook and input query vector to find the K nearest centroid IDs to be used as a query predicate on the indexed centroid IDs.

The indexing module 220 may generate index such that a vector field can appear in any order in the fields of the index. For example, a vector field may be a leading field of the index or may appear in any other position in the order in which fields are specified in the corresponding create index command used to create the index.

The query module 230 receives queries and processes them. The query module 230 may include components such as query parser, query rewrite module, query optimizer, and so on. According to an embodiment, the query module 230 generates an execution plan for the query. The execution plan may be represented as a graph of operators, each operator receiving one or more inputs, performing an operation on the one or more inputs and generating a result that may be passed as input to another operator or may be determined to be the result of the query.

The database system 110 supports use cases when there is low selectivity on the scalar predicates and the composite vector index is used to narrow down the search scope for the vector field. For example, a catalog use case where scalar fields such as “product=adidas”, “size=11” can be used to eliminate large number of catalog items before performing similarity search on the fields such as “description” or “image.”

According to an embodiment, a particular composite vector index sorts the data in ascending order of the fields specified for the index. However, a user can specify whether the order of a particular field in the index should be descending. Following is an example of an type of index that may be created by the indexing module 220. Th e index created includes three scalar fields, product, size, price, and a vector field activity.
CREATE INDEX ix_pr_size_price_activity ON
   item(product, size, price, activity VECTOR)
      WITH {“dimension”: 128,
         “train_list”: 10000,
         “description”: “description of the index”,
         “similarity”: “L2”,
         “scan_nprobes”: 3};

The index may be created with various attributes of the index specified, for example, “dimension” specifying number of dimensions of the vector field; “train list” specifying a sample set of vectors to be used for index training; a description of the index; “similarity: specifying the distance functions used for similarity comparison for example, L2 norm; “scan_nprobes” parameter specifying the number of cells to search for each scan. This index can be used to search for vector field activity along with constraints based on scalar fields such as product, size, and so on. For example, the system may receive a request for all activities that involve running and have size 10.

An index may include multiple vector fields. Following is an example of an index with multiple vector fields, activity and education.
CREATE INDEX ix_pr_size_price ON item(product, size DESC,
   activity VECTOR, education VECTOR, price)
   WITH {“vectors”: [
      {“field”: “activity”,
      “dimension”: 128,
      “train_list”: 10000,
      “description”: “description of activity field”,
      “similarity”: “L2,
      “scan_nprobes”: 3},
      {“field”:“education”,
      “dimension”: 64,
      “train_list”: 1000,
      “description”: “description of education field”,
      “similarity”: “Cosine”,
      “scan_nprobes”: 4}
      ]};

This index can be used to searching on vector field activity along with constraints based on scalar fields such as product, size, and so on. According to an embodiment, the system comprises an index advisor tool that generates recommendations of the indexes that need to be created for efficiently processing certain query or queries. The system may automatically generate the indexes that are determined by the system for processing certain types of queries.

According to an embodiment, the database system 110 allows queries to specify an operator indicating an approximate vector distance from a particular vector field or a vector field value. For example, the system supports an APPROX_VECTOR_DISTANCE function that takes as input, an input vector field name, an input value of a vector field, and optionally a distance metric that determines the distance of values stores in the input vector field from the input value. The function APPROX_VECTOR_DISTANCE may be used for ordering results of the query, for example, to order records by distance of their vector field from an input vector field value, or to filter records that have the vector field value within a threshold distance of an input vector field value.

Following are examples of types of queries that the query module 230 may receive and process. The following query is a request to find top 10 shoes of size 11, price between 80 and 120, matching the closest activity to the user. Accordingly, the query is based on scalar fields product, size, and price and a similarity based on vector field activity.
SELECT brand, name, image
FROM item
WHERE product=‘shoes’
   AND size=11
   AND price between 80 and 120
ORDER BY APPROX_VECTOR_DISTANCE(activity, $useractivity, “L2”)
LIMIT 10;

The following query finds top 10 shoes of size 11, price between 80 and 120, matching the closest activity to the user.
SELECT brand, name, image
FROM item
WHERE product=‘shoes’
   AND size IN [10, 11]
   AND price between 80 and 120
ORDER BY size DESC, APPROX_VECTOR_DISTANCE(activity, $useractivity, “L2”)
LIMIT 10;

The following query finds top 10 shoes of size 10, 11, price between 80 and 120, matching the closest activity to the user and within closest activity closest user education.
SELECT brand, name, image
FROM item
WHERE product=‘shoes’
   AND size=10
   AND price between 80 and 120
ORDER BY APPROX_VECTOR_DISTANCE(activity, $useractivity, “L2”), APPROX_VECTOR_DISTANCE(education, $usereducation, “Cosine”)
LIMIT 10;

Accordingly, the query module 230 uses the composite vector index 240 to process queries based on vector fields and scalar fields.

### Process

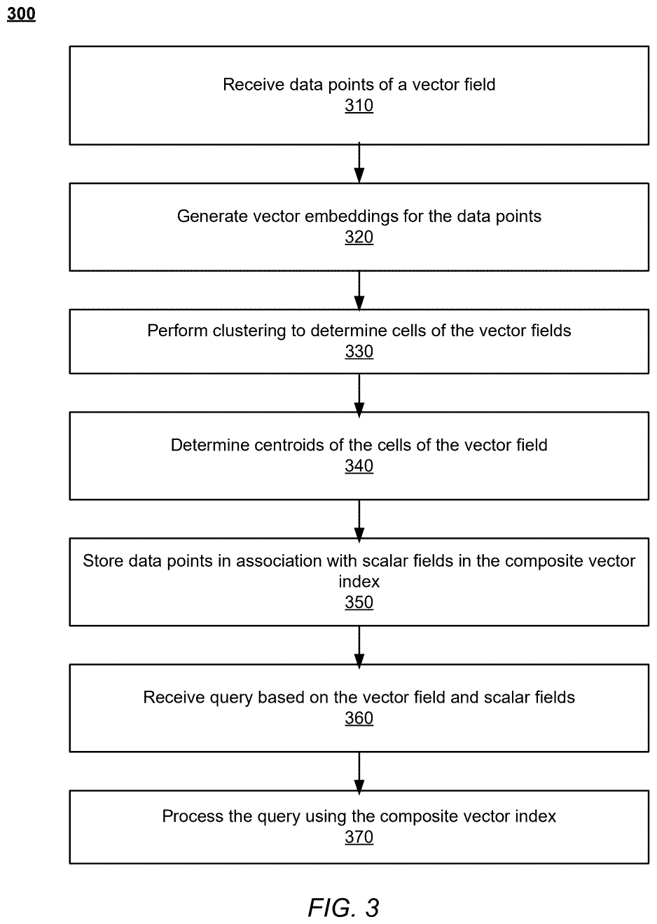

FIG. 3 is a flowchart of one embodiment of a method for creating a composite vector index, according to an embodiment. In various embodiments, the method includes different or additional steps than those described in conjunction with FIG. 3. Further, in some embodiments, the steps of the method may be performed in different orders than the order described in conjunction with FIG. 3. The method described in conjunction with FIG. 3 may be carried out by the database system 110 in various embodiments.

The database system 110 receives 310 data points of a vector field, for example, a vector field storing values that are natural language text, or media objects such as an images, audio, or videos, and so on. The embedding generator 210 generates 320 vector embeddings for the data points. Each vector embedding is represented as a multi-dimensional vector. The quantization module 225 performs clustering 330 of the vector embeddings to determine cells of the vector field. For example, the quantization module 225 may perform k-means clustering to determine the clusters. The quantization module 225 determines 340 centroids of the clusters. The centroid may be determined using an aggregate value based on the vectors of the cell, for example, a mean or media vector based on the vectors of the cell. The indexing module 220 stores 350 the data points of the vector field in association with corresponding values of the scalar fields as the composite vector index. The query module 230 receives 360 a query based on the vector field and scalar fields. The query module 230 processes the query using the composite vector index 240.

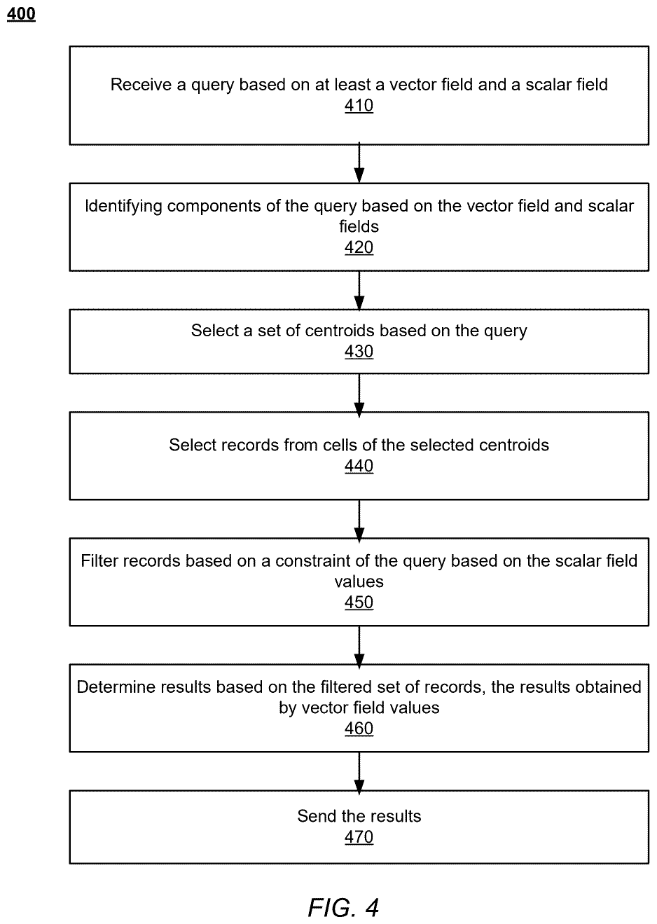

FIG. 4 is a flowchart of one embodiment of a method for indexing and querying spatiotemporal data, indexing and querying spatiotemporal data. In various embodiments, the method includes different or additional steps than those described in conjunction with FIG. 4. Further, in some embodiments, the steps of the method may be performed in different orders than the order described in conjunction with FIG. 4. The method described in conjunction with FIG. 4 may be carried out by the database system 110 in various embodiments.

The indexing module 220 receives 410 a query based on at least a vector field and a scalar field. The vector field may be part of the order by clause of the query. The indexing module 230 identifies 420 components of the query, for example, a component based on one or more vector fields and another component based on the scalar fields. The indexing module 220 uses the indexes generated by the indexing module 220 to select 430 a set of centroids based on the first component of the query. For example, the indexing module 220 may use an index to select cells that have centroids within a threshold vector distance of a particular vector field value as specified by the first component of the query. The indexes generated by the indexing module 220 are used to select centroids that are within the threshold vector distance of the particular vector field value.

The indexing module 220 selects 440 records from the cells corresponding to the centroids that were selected. The query module 230 filters 450 records based on the second component, for example, a constraint based on scalar values, thereby reducing the number of records that are subsequently processed. The query module 230 filters 450 records to determine a set S1 of records.

The indexing module 220 further selects a subset S2 of the records from the set S1 based on the first component, i.e., a vector component of the query. The selection of the subset of records S2 based on the first component is computationally expensive since the computation involves vector comparison. The process discloses in FIG. 4 improves the efficiency of computation of the query processing by reducing the number of vector comparisons that are performed by filtering the records to determine the set S1 of records using the second component, i.e., the scalar component before selecting the subset S2 of records based on the vector comparison. As a result, the number of vector comparisons performed is reduced significantly. The query module 230 uses the subset S2 of records to determine 460 results of the query and sends 470 the results to the requestor, for example, a client device or client application that sent the query. As another example, the first component may be an order by clause that orders the records based on their vector distance from a particular vector field value and selects the top K (e.g., top 10) records.

According to an embodiment, the query module 230 determines queries using fields such that there is low selectivity on a predicate based on scalar fields. In these situations, the query module 230 uses the predicate to narrow down the search scope for the vector field. Accordingly, the indexing module 220 uses the indexes generated by the indexing module 220 to first filter the records based on the scalar fields to identify a subset of records. The query module 230 then performs the processing based on the vector field to the subset of records. As an example, the query may represent a catalog search for shoes that match a given image and have particular use case based on their description. In this example, the query module 230 uses scalar fields such as “product=xyz”, “size=11” to eliminate a large number of catalog items before performing similarity search on vector fields such as “description” or “image.”

According to an embodiment, the system keeps track of the cluster occupancy distribution i.e. the number of vectors assigned to each cluster. If over time, due to the incremental updates to the vectors, the imbalance between clusters is higher than the predefined thresholds (i.e., some clusters contain significantly more vectors than others), the system initiates automatic rebuilding of the index. This retrains the codebook and allows more accurate query results. This may be achieved by rebuilding one index replica at a time to ensure index availability at all times.

Vector may be represented as an array of floats depending on dimensions the size can be a couple of kilobytes of data. This can impact storage/transfer of bytes. To optimize the processing the system according to an embodiment, stores base64 strings to handle those. On the same data the system may process non vector queries. Increasing the size of the documents impacts latency, scalability and TCO (total cost of ownership). To minimize impact the system stores vectors as part of a set of attributes referred to as X-attributes that are stored outside document/but associated with the document. Non vector queries retrieve actual documents and X-attributes vector attributes are used to retrieve document and X-attributes.

According to an embodiment, the database system 110 includes a rule-based optimizer to find the indexes most qualified to scan most predicates including predicates based on vector fields and choosing the one with the most predicates in the query.

According to an embodiment the database system makes cost-based decisions. There may be multiple qualified indexes and the optimizer makes a cost-based decision based on the cost of the scan. The system determines the cost of using each index and uses the cost estimates to make the decision.

### Composite Vector Index Support

According to various embodiments, the system supports various features of composite vector index support:

According to an embodiment, the system supports a partial index for a composite vector index. The system processes the WHERE clause similar to a partial index for scalar fields. For a query, the planner first checks that the WHERE clause of a partial index is satisfied before considering the index for a query.

According to an embodiment, the system supports a partitioned index for a composite vector index. The system processes the PARTITION BY clause similar to a regular partitioned index for scalar fields. For a query, the indexer uses index spans generated by the query planner to perform partition elimination when possible. When multiple index partitions need to be scanned for a query, the index client is responsible for combining the result from different index partitions before returning to the query service.

According to an embodiment, the system supports a functional index for a composite vector index. The vector index key cannot be a functional key, but other index keys can.

According to an embodiment, the system supports array indexes for a composite vector index. There are two subcategories here: (1) array index with vector index key as non-array index key, and (2) array index with vector index key as array index key

In the case of array index with vector index key as non-array index key, the documents contain a separate array field that is distinct from the vector embedding field. An index is created with an array index key on the array field, plus the vector index key. For such indexes the system supports both the DISTINCT and the ALL variants of the array index key. The handling of such an array index is similar to how an array index is handled without the vector index key.

In the case of array index with vector index key as array index key, the documents contain an array of vector embeddings. Each array element contains either the vector embedding itself, or an object with a vector embedding field inside the object. When an array index is created only the ALL variant of the array index key is supported. With such an array index the system processes a query that utilizes vector search functionality using an UNNEST operation on the array field, and then performs vector search on the UNNEST result.

According to an embodiment, the system supports FLATTEN_KEYS on an array index key where a vector index key can be one of the fields used in the FLATTEN_KEYS specification. In this case each element of the array is an object, with a vector embedding field as one of the fields inside the object. The array index key can include multiple fields in the object, one of which is the vector embedding field. Only the ALL variant of the array index key is supported, and such index can be used in a query that first UNNEST the array field then has predicates on individual fields of the UNNEST result as well as a vector search operation on the vector embedding field.

According to an embodiment, the system supports index pushdown. Index pushdown may greatly improve query performance when it is applicable. The same is true for a composite vector index. Since a vector search query always has an ORDER BY clause (which defines the vector search), and typically has a LIMIT clause (only top matches are requested), ORDER and/or LIMIT pushdown is important for a vector search query.

In order to perform ORDER and LIMIT pushdown, the indexer evaluates ALL the predicates in a query. This is a preexisting requirement and remains true for a composite vector index as well.

The criteria for ORDER pushdown for a composite vector index is more relaxed than a regular secondary index. For a regular secondary index, for ORDER pushdown to work the ORDER BY terms must match exactly the index keys in order, with some minor exceptions such as an equality predicate on an index key or index condition. Each order term also needs to match an index key in terms of collation order (ascending/descending) and null positioning (NULLS FIRST/LAST). For a composite vector index with a vector search query, this is relaxed such that as long as each ORDER BY term is part of the index keys (including the vector index key), the ORDER can be pushed down. This special ORDER pushdown for a composite vector index also requires that the LIMIT be pushed down as well, otherwise the ORDER cannot be pushed down.

The system may perform LIMIT pushdown for a composite vector index. The LIMIT pushdown for a composite vector index (for a vector search query) requires ORDER pushdown first. In fact for a vector search query either both ORDER and LIMIT are pushed down, or neither can be done.

The composite vector index itself does not support reranking operation, since the index does not store the full vector (it only stores a “quantized” version of each vector). If reranking is requested by the query (via an optional argument to the APPROX_VECTOR_DISTANCE function), the query service will push a larger LIMIT to the indexer to retrieve more candidates, then perform the reranking operation after retrieving the full vector from a document.

### Technical Improvements

The system disclosed herein provides several technical improvements over conventional indexing and query processing techniques. Advancements in vector search technology have been driven by the rapid progress in machine learning, particularly in the field of neural networks. Large language models and embedding techniques have enabled the creation of dense vector representations that capture complex semantic relationships in data. The vectors generated from neural networks to represent data such as natural language text, media objects, and so on can have a very large number of dimensions, for example, several hundreds or thousands of dimensions.

Existing systems impose specific requirements on the data to support vector searches. For example, certain systems require documents to be structured so that indexed fields must be stored under a metadata field. Some systems combine multiple dimensions of the vector into a single dimension and then query the single dimension as a scalar. Such techniques may be computationally feasible for vector with very small number of dimensions, for example, two dimensions. However, for vectors with several thousand dimensions, converting such large number of dimensions into a single dimension is not feasible and not comparison of such large values would be highly inefficient, even if such values could be generated and stored. Such systems are computationally inefficient and also have poor storage efficiency.

In contrast, the techniques disclosed do not require such transformation of the vector data and the vector dimensions can be stored separately, for example, as an array. The system as disclosed improves efficiency of execution by reducing the number of vector comparisons that are performed, for example, by utilizing selectivity of scalar operations to reduce the number of vector fields that are processed or by using centroids of cells to reduce the number of vector operations that are performed. Since vector operations such as vector comparisons for large vectors are highly computationally intensive, reducing the number of such operations that are performed provides significant performance improvement. Furthermore, the vector fields are treated as any scalar field, thereby improving the usability of the system since the system does not require significant additional steps from users for handling vector fields.

### Computer Architecture

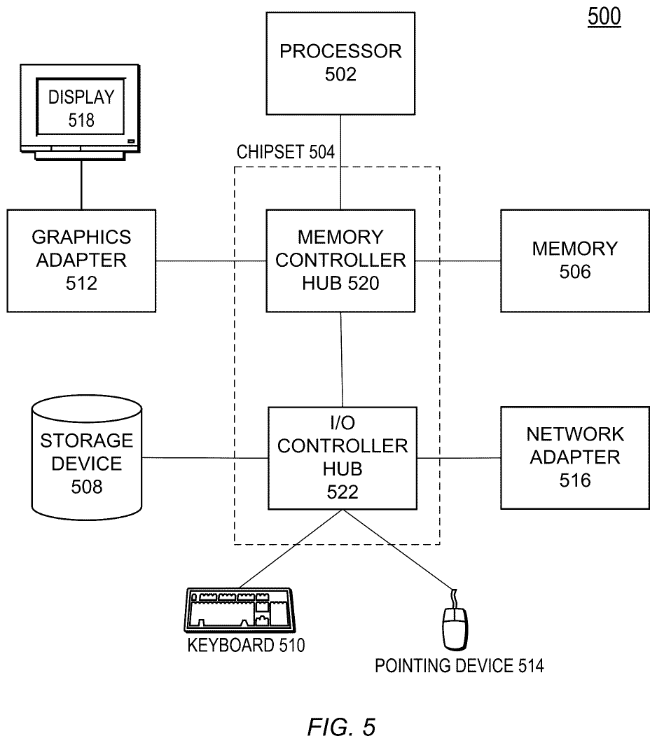

FIG. 5 is a high-level block diagram illustrating a functional view of a typical computer system for use as one of the entities illustrated in the system environment of FIG. 1 according to an embodiment. Illustrated are at least one processor 502 coupled to a chipset 504. Also coupled to the chipset 504 are a memory 506, a storage device 508, a keyboard 510, a graphics adapter 512, a pointing device 514, and a network adapter 516. A display 518 is coupled to the graphics adapter 512. In one embodiment, the functionality of the chipset 504 is provided by a memory controller hub 520 and an I/O controller hub 522. In another embodiment, the memory 506 is coupled directly to the processor 502 instead of the chipset 504.

The storage device 508 is a non-transitory computer-readable storage medium, such as a hard drive, compact disk read-only memory (CD-ROM), DVD, or a solid-state memory device. The memory 506 holds instructions and data used by the processor 502. The pointing device 514 may be a mouse, track ball, or other type of pointing device, and is used in combination with the keyboard 510 to input data into the computer system 500. The graphics adapter 512 displays images and other information on the display 518. The network adapter 516 couples the computer system 500 to a network.

As is known in the art, a computer system 500 can have different and/or other components than those shown in FIG. 5. In addition, the computer system 500 can lack certain illustrated components. For example, a computer system 500 acting as a server (e.g., a query server 112) may lack a keyboard 510 and a pointing device 514. Moreover, the storage device 508 can be local and/or remote from the computer system 500 (such as embodied within a storage area network (SAN)).

The computer system 500 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 1008, loaded into the memory 506, and executed by the processor 502.

The types of computer systems 500 used by the entities of FIG. 1 can vary depending upon the embodiment and the processing power used by the entity. For example, a client device 120 may be a mobile phone with limited processing power, a small display 518, and may lack a pointing device 514. The entities of the database system 110, in contrast, may comprise multiple blade servers working together to provide the functionality described herein.

### Additional Considerations

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the embodiments is intended to be illustrative, but not limiting.

What is claimed is:

1. A method for querying data stored in a database, the method comprising:
storing a composite vector index associating a plurality of fields, the plurality of fields comprising one or more vector fields and one or more scalar fields, each vector field comprising vector embeddings and each scalar field comprising scalar values, wherein values of a vector field are grouped as cells, each cell associated with a centroid value;
receiving, from a client device, a query based on at least a vector field and a scalar field;
extracting a first component of the query based on the vector field and a second component of the query comprising a constraint based on the scalar field;
identifying a set of cells of the vector field based on the first component of the query;
accessing a set of records from the set of cells;
determining a subset of records from the set of records, wherein the subset of records satisfy the constraint specified in the second component of the query;
determining a result of the query by selecting a set of vectors from the subset of records, wherein the set of vectors satisfy the first component of the query; and
sending the result of the query to the client device.

2. The method of claim 1, wherein the first component of the query specifies a measure of a distance from a particular vector field value such that the query represents a request for records based on their distance from the particular vector field value.

3. The method of claim 1, wherein the first component of the query is an order by clause that orders results based on a distance of the vector field from a particular vector field value and the second component of the query specifies the constraint based on the scalar field for filtering results.

4. The method of claim 1, wherein a vector field stores natural language text such that the vector embeddings represent a vector representation generated by providing the natural language text to a neural network.

5. The method of claim 1, wherein a vector field stores media objects such that the vector embeddings represent a vector representation generated by providing a media object to a neural network, wherein the media object is one of an image, a video, or an audio.

6. The method of claim 1, further comprising:
performing clustering of a set of records based on vector fields to determine cells; and
for each cell determining a centroid.

7. The method of claim 1, wherein the database is a relational database, wherein each record is represented by one or more rows of tables stored in the relational database, wherein a field is represented by a column of a table.

8. The method of claim 1, wherein the database is a document database, wherein each record is represented by a document or a portion of a document and a field is represented by an attribute of the document.

9. A non-transitory computer readable storage medium, storing instructions that when executed by one or more computer processors cause the one or more computer processors to perform steps of a method for querying data stored in a database, the steps comprising:
storing a composite vector index associating a plurality of fields, the plurality of fields comprising one or more vector fields and one or more scalar fields, each vector field comprising vector embeddings and each scalar field comprising scalar values, wherein values of a vector field are grouped as cells, each cell associated with a centroid value;
receiving, from a client device, a query based on at least a vector field and a scalar field;
extracting a first component of the query based on the vector field and a second component of the query comprising a constraint based on the scalar field;
identifying a set of cells of the vector field based on the first component of the query;
accessing a set of records from the set of cells;
determining a subset of records from the set of records, wherein the subset of records satisfy the constraint specified in the second component of the query;
determining a result of the query by selecting a set of vectors from the subset of records, wherein the set of vectors satisfy the first component of the query; and
sending the result of the query to the client device.

10. The non-transitory computer readable storage medium of claim 9, wherein the first component of the query specifies a measure of a distance from a particular vector field value such that the query represents a request for records based on their distance from the particular vector field value.

11. The non-transitory computer readable storage medium of claim 9, wherein the first component of the query is an order by clause that orders results based on a distance of the vector field from a particular vector field value and the second component of the query specifies the constraint based on the scalar field for filtering results.

12. The non-transitory computer readable storage medium of claim 9, wherein a vector field stores natural language text such that the vector embeddings represent a vector representation generated by providing the natural language text to a neural network.

13. The non-transitory computer readable storage medium of claim 9, wherein a vector field stores media objects such that the vector embeddings represent a vector representation generated by providing a media object to a neural network, wherein the media object is one of an image, a video, or an audio.

14. The non-transitory computer readable storage medium of claim 9, wherein the instructions further cause the one or more computer processors to perform steps comprising:
performing clustering of a set of records based on vector fields to determine cells; and
for each cell determining a centroid.

15. The non-transitory computer readable storage medium of claim 9, wherein the database is a relational database, wherein each record is represented by one or more rows of tables stored in the relational database, wherein a field is represented by a column of a table.

16. The non-transitory computer readable storage medium of claim 9, wherein the database is a document database, wherein each record is represented by a document, or a portion of a document and a field is represented by an attribute of the document.

17. A computer system comprising:
one or more computer processors; and
a non-transitory computer readable storage medium, storing instructions that when executed by one or more computer processors cause the one or more computer processors to perform steps of a method for querying data stored in a database, the steps comprising:
storing a composite vector index associating a plurality of fields, the plurality of fields comprising one or more vector fields and one or more scalar fields, each vector field comprising vector embeddings and each scalar field comprising scalar values, wherein values of a vector field are grouped as cells, each cell associated with a centroid value;
receiving, from a client device, a query based on at least a vector field and a scalar field;
extracting a first component of the query based on the vector field and a second component of the query comprising a constraint based on the scalar field;
identifying a set of cells of the vector field based on the first component of the query;
accessing a set of records from the set of cells;
determining a subset of records from the set of records, wherein the subset of records satisfy the constraint specified in the second component of the query;
determining a result of the query by selecting a set of vectors from the subset of records, wherein the set of vectors satisfy the first component of the query; and
sending the result of the query to the client device.

18. The computer system of claim 17, wherein the first component of the query specifies a measure of a distance from a particular vector field value such that the query represents a request for records based on their distance from the particular vector field value.

19. The computer system of claim 17, wherein the first component of the query is an order by clause that orders results based on a distance of the vector field from a particular vector field value and the second component of the query specifies the constraint based on the scalar field for filtering results.

20. The computer system of claim 17, wherein a vector field stores natural language text such that the vector embeddings represent a vector representation generated by providing the natural language text to a neural network.
